(19) United States
(12) Patent Application Publication
(10) Pub. No.: US 2003/0108683 A1
(43) Pub. Date: Jun. 12, 2003

(54) Manufacturing method for nano-porous coatings and thin films

(76) Inventor: L. W. Wu, Auburn, AL (US)

Correspondence Address: L. W. Wu, 2076, S Evergreen Dr., Aubrun, AL, 36830, US

(21) Appl. No.: 10/013,276

(22) Filed: Dec. 12, 2001

(51) Int. Cl. H05H 1/48; H01T 14/00

(52) U.S. Cl. 427/580

(57) ABSTRACT

A method for producing a nano-porous coating onto a solid substrate from a precursor material selected from the group consisting of a metal, metal alloy, metal compound, and ceramic material. In one embodiment, the method includes (a) providing an ionized arc nozzle that includes a consumable electrode, a non-consumable electrode, and a working gas flow to form an ionized arc between the two electrodes, wherein the consumable electrode provides the precursor material vaporizable therefrom by the ionized arc; (b) operating the arc nozzle to heat and at least partially vaporize the precursor material for providing a stream of nanometer-sized vapor clusters into a chamber in which the substrate is disposed; (c) introducing a stream of reactive gas into the chamber to impinge upon the stream of vapor clusters and exothermically react therewith to produce substantially nanometer-sized metal compound or ceramic clusters; and (d) heat treating the metal compound or ceramic clusters so that a non-zero proportion of the clusters are converted into a solid state when impinging upon the substrate; and (e) directing the metal compound or ceramic clusters to impinge upon and deposit onto the substrate for forming the nano-porous coating. Optionally, the coating may be separated from the substrate to obtain a nano-porous film.

### FIELD OF THE INVENTION

The present invention relates to a method for producing a nano-porous coating or thin film on a substrate. In particular, the invention provides a method that is capable of mass-producing coatings or thin films for sensor, membrane, and electrode applications.

### BACKGROUND OF THE INVENTION

Porous solids have been utilized in a wide range of applications, including membranes, catalysts, sensor, electrodes, photonic crystals, microelectronic device substrate, absorbents, light-weight structural materials, and thermal, acoustical and electrical insulators. These solid materials are usually classified according to their predominant pore sizes: (i) micro-porous solids, with pore sizes <1.0 nm; (ii) macro-porous solids, with pore sizes exceeding 50 nm (normally up to 50 nm); and (iii) meso-porous solids, with pore sizes intermediate between 1.0 and 50 nm. The term “nano-porous solid” means a solid that contains essentially nanometer-scaled pores (1-1,000 nm) and, therefore, covers “meso-porous solids” and the lower-end of “macro-porous solids”.

A number of methods have previously been used to fabricate macro- or meso-porous inorganic films. Meso-porous solids can be obtained by using surfactant arrays or emulsion droplets as templates. Latex spheres or block copolymers can be used to create silica structures with pore sizes ranging from 5 nm to 1 μm. Nano-porous silica films also can be prepared using a mixture of a solvent and a silica precursor, which is deposited on a substrate. When forming such nano-porous films by spin-coating, the film coating is typically catalyzed with an acid or base catalyst and additional water to cause polymerization or gelation and to yield sufficient strength so that the film does not shrink significantly during drying.

Another method for providing nano-porous silica films was based on the concept that film thickness and density (porosity, or dielectric constant) can be independently controlled by using a mixture of two solvents with dramatically different volatility. The more volatile solvent evaporates during and immediately after precursor deposition. The silica precursor, e.g., partially hydrolyzed and condensed oligomers of tetraethoxysilane (TEOS), is applied to a suitable substrate and polymerized by chemical and/or thermal methods until it forms a gel. The second solvent, called the Pore Control Solvent (PCS) is usually then removed by increasing the temperature until the film is dry. The density or porosity of the final film is governed by the volume ratio of low volatility solvent to silica. It has been found difficult to provide a nanoporous silica film having sufficiently optimized mechanical properties, together with a relatively even distribution of material density throughout the thickness of the film.

Still another method for producing nano-porous inorganic materials is by following the sol-gel techniques, whereby a sol, which is a colloidal suspension of solid particles in a liquid, transforms into a gel due to growth and interconnection of the solid particles. Continued reactions within the sol will lead to a critical chemical state in which one or more molecules within the sol eventually reach macroscopic dimensions so that they form a solid network which extends substantially throughout the sol. At this chemical state, called the gel point, the material begins to become a gel. Hence, a gel may be defined as a substance that contains a continuous solid skeleton enclosing a continuous liquid phase. As the skeleton is porous, the term “gel” as used herein means an open-pored solid structure enclosing a pore fluid. Removal of the pore fluid leaves behind empty pores.

The following publications represent the state-of-the-art of the methods for the preparation of nano-porous films or coatings:

1. O. D. Velev, et al. “Porous silica via colloidal crystallization,” Nature, 389 (Oct.1997) 447-448.

2. K. M. Kulinowsky, et al. “Porous metals from colloidal templates,” Advanced Materials, 12 (2000) 833.

3. P. R. Coronado, et al., “Method for rapidly producing micro-porous and meso-porous materials,” U.S. Pat. No. 5,686,031 (Nov. 11, 1997).

4. S. C. Jha, et al., “Composite porous media,” U.S. Pat. No. 6,080,219 (Jun. 27, 2000).

5. M. Moskovits, et al. “Nanoelectric devices,” U.S. Pat. No. 5,581,091 (Dec. 3, 1996).

6. R. L. Bedard, et al., “Semiconductor device containing a semiconducting crystalline nanoporous material,” U.S. Pat. No. 5,594,263 (Jan. 14, 1997).

7. D. L. Gin, et al., “Highly ordered nanocomposites via a monomer self-assembly in situ condensation approach,” U.S. Pat. No. 5,849,215 (Dec. 15, 1998).

8. T. J. Pinnavaia, et al. “Porous inorganic oxide materials prepared by non-ionic surfactant templating route,” U.S. Pat. No. 5,622,684 (Apr. 22, 1997).

9. C. J. Brinker, et al., “Method for making surfactant-templated, high-porosity thin films,” U.S. Pat. No. 6,270,846 (Aug. 7, 2001).

10. P. J. Bruinsma, et al., “Mesoporous-silica films, fibers, and powders by evaporation,” U.S. Pat. No. 5,922,299 (Jul. 13, 1999).

11. R. Leung, et al., “Nanoporous material fabricated using a dissolvable reagent,” U.S. Pat. No. 6,214,746 (Apr. 10, 2001).

12. R. Leung, et al., “Low dielectric constant porous films,” U.S. Pat. No. 6,204,202 (Mar. 20, 2001).

13. K. Lau, et al., “Nanoporous material fabricated using polymeric template strands,” U.S. Pat. No. 6,156,812 (Dec. 5, 2000).

14. S. K. Gordeev, et al., “Method of producing a composite, more precisely nanoporous body and a nanoporous body produced thereby,” U.S. Pat. No. 6,083,614 (Jul. 4, 2000).

Despite the availability of previous methods for preparing nano-porous silica films, an urgent need exists for a more general method capable of producing a greater variety of metals, metal compounds and ceramic materials in a thin film or coating form. Furthermore, most of the prior art techniques for the preparation of porous coatings are slow and tedious and, hence, not amenable to mass production.

The present invention has been made in consideration of these problems in the related prior arts, and its object is to provide a cost-effective method for directly forming a nano-porous coating onto a solid substrate. In order to produce a uniform, thin, and nano-porous metal compound or ceramic coating on a substrate, it is essential to produce depositable clusters that are on the nanometer scale prior to striking the substrate. These clusters must be capable of partially adhering to each other through parting sintering, liquid bonding, and/or vapor bonding and coalescence between clusters.

In one embodiment of the present invention, a method entails producing ultra-fine clusters of metal, metal compound or ceramic species and directing these clusters to impinge upon a substrate, permitting these clusters to become solidified thereon to form a thin coating layer. These nano clusters are produced by operating an ionized arc nozzle or a multiplicity of arc nozzles in a chamber to produce metal vapor clusters and by introducing a reactive gas (e.g., oxygen) into the chamber to react with the metal clusters, thereby converting these metal clusters into nanometer-sized compound or ceramic (e.g., oxide) clusters. The heat generated by the exothermic oxidation reaction can in turn accelerate the oxidation process and, therefore, make the process self-sustaining or self-propagating. The great amount of heat released can also help to maintain the resulting oxide clusters in the vapor, liquid, and/or high-temperature solid state. Rather than cooling and collecting these clusters to form individual powder particles, these nanometer-sized vapor clusters can be directed to form an ultra-thin oxide coating onto a solid substrate.

### SUMMARY OF THE INVENTION

A preferred embodiment of the present invention is a method for producing an optically transparent and electrically conductive coating onto a substrate. The method includes three primary steps: (a) operating an ionized or plasma arc nozzle to provide a stream of nano-sized metal vapor clusters into a coating chamber in which the substrate is disposed (the ionized arc nozzle includes a consumable electrode, a non-consumable electrode, and a working gas flow to form an ionized arc between the two electrodes, wherein the consumable electrode providing a metal material vaporizable from the consumable electrode by the ionized arc); (b) introducing a stream of oxygen-containing gas into this chamber to impinge upon the stream of metal vapor clusters and exothermically react therewith to produce substantially nanometer-sized metal oxide clusters; (c) heat-treating the produced clusters so that a non-zero proportion of the clusters are in a high temperature solid state when striking the substrate; and (d) directing these metal oxide clusters to deposit onto the substrate for forming the desired coating. If other reactive gases, instead of oxygen, are used, other compound or ceramic than oxide clusters are formed to produce non-oxide nano-porous coatings. Instead, if non-reactive gases such as inert gases are introduced to impinge upon the stream of metal vapor clusters, metal coatings are produced.

In the first step, the method begins with feeding a precursor wire or rod of a pure metal, metal alloy, metal compound, or ceramic) into the upper portion of a coating chamber. The wire or rod is supported on the top surface of a consumable electrode. The leading tip of the wire or rod is exposed to an arc formed between the consumable electrode and a non-consumable electrode in the presence of a working gas flow and under a high-current condition. The arc will heat and vaporize the wire or rod tips to form nano-sized clusters of the precursor material. While the wire tip is being consumed by the arc, the wire is continuously or intermittently fed into an arc zone so that the leading tip is maintained at a relatively constant position with respect to the arc flame tail. In one preferred embodiment, an oxygen-containing gas is introduced into the chamber to react with the metal vapor clusters for forming metal oxide clusters. In this case, the oxygen-containing gas serves to provide the needed oxygen for initiating and propagating the exothermic oxidation reaction to form the oxide clusters in the liquid or vapor state, which are then deposited onto the substrate to form a thin coating.

The present invention provides a low-cost method that is capable of readily heating up the wire to a temperature as high as 6,000° C. In an ionized arc, the precursor material is rapidly heated to an ultra-high temperature and is vaporized essentially instantaneously to form atomic-, molecular-, or nanometer-scaled vapor clusters. Since the wire or rod can be continuously fed into the arc-forming zone, the arc vaporization is a continuous process, which means a high coating rate. The atomic-, molecular-, or nanometer-scaled vapor clusters of a metal, metal compound, or ceramic material are directed to pass through a heat treatment zone in such a fashion that a certain amount of the clusters are in a high-temperature but solid state which are capable of partially sintering but not fully coalescing. In other words, individual clusters are bonded together at or near their points of contact only, leaving behind nanometer-scaled pores between clusters.

The presently invented method is applicable to essentially all metallic materials, including pure metals and metal alloys. The precursor material can also be any metal compound or ceramic material that is vaporizable.

In the case of a pure metal or metal alloy, the reactive gas is preferably an oxygen-containing gas, which includes oxygen and, optionally, a predetermined amount of a second gas selected from the group consisting of argon, helium, hydrogen, carbon, nitrogen, chlorine, fluorine, boron, sulfur, phosphorus, selenium, tellurium, arsenic and combinations thereof. Argon and helium are noble gases and can be used as a carrier gas (without involving any chemical reaction) or as a means to regulate the oxidation rate. Other gases may be used to react with the metal clusters to form compound or ceramic phases of hydride, oxide, carbide, nitride, chloride, fluoride, boride, sulfide, phosphide, selenide, telluride, and arsenide in the resulting coating if so desired.

If the reactive gas contains oxygen, this reactive gas will rapidly react with the metal clusters to form nanometer-sized ceramic clusters (e.g., oxides). If the reactive gas contains a mixture of two or more reactive gases (e.g., oxygen and nitrogen), the resulting product will contain a mixture of oxide and nitride clusters. If the metal composition is a metal alloy or mixture (e.g., containing both indium and tin elements) and the reactive gas is oxygen, the resulting product will contain ultra-fine indium-tin oxide clusters that can be directed to deposit onto a glass, plastic, metal, or ceramic substrate.

At a high arc temperature, metal clusters are normally capable of initiating a substantially spontaneous reaction with a reactant species (e.g., oxygen). In this case, the reaction heat released is effectively used to sustain the reactions in an already high temperature environment.

Advantages of the present invention are summarized as follows:

1. A wide range of metal compounds and ceramic materials can be used as the precursor material. Furthermore, a wide variety of metallic elements can be readily converted into nanometer-scaled ceramic or compound clusters for deposition onto a solid substrate. The starting metal materials can be selected from any element in the periodic table that is considered to be metallic. In addition to oxygen, partner gas species may be selected from the group consisting of hydrogen, carbon, nitrogen, chlorine, fluorine, boron, sulfur, phosphorus, selenium, tellurium, arsenic and combinations thereof to help regulate the oxidation rate and, if so desired, form respectively metal hydrides, oxides, carbides, nitrides, chlorides, fluorides, borides, sulfides, phosphide, selenide, telluride, arsenide and combinations thereof. No known prior-art technique is so versatile in terms of readily producing so many different types of ceramic coatings on a substrate.

2. In the case of a metal material, the metal composition can be an alloy of two or more elements which are uniformly dispersed. When broken up into nano-sized clusters, these elements remain uniformly dispersed and are capable of reacting with oxygen to form uniformly mixed ceramic coating, such as indium-tin oxide. No post-fabrication mixing treatment is necessary.

3. The wire can be fed into the arc zone at a high rate with its leading tip readily vaporized. This feature makes the method fast and effective and now makes it possible to mass produce coatings on a substrate cost-effectively.

4. The system needed to carry out the invented method is simple and easy to operate. It does not require the utilization of heavy and expensive equipment such as a laser or vacuum-sputtering unit. In contrast, it is difficult for a method that involves a high vacuum to be a continuous process. The over-all product costs produced by the presently invented vacuum-free method are very low.

### BRIEF DESCRIPTION OF THE DRAWINGS

FIG. 1 shows the schematic of a system that can be used in the practice of a preferred embodiment of the presently invented method for producing oxide coating on a substrate.

FIG. 2 shows the schematic of another system (a multi-arc system) that can be used in the method for producing oxide coating on a substrate.

### DETAILED DESCRIPTION OF PREFERRED EMBODIMENTS

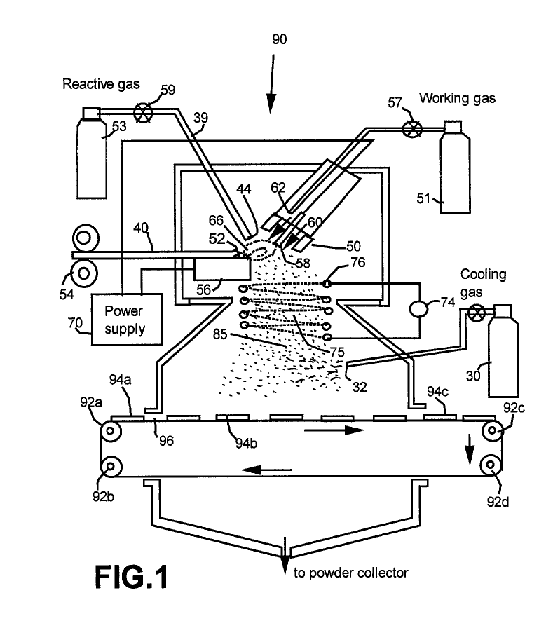

FIG. 1 schematically shows a coating system that can be used in practicing the method for producing a nano-porous coating on a solid substrate. This apparatus includes four major functional components: (1) a coating chamber 90, (2) an ionized arc nozzle 50 located at the upper portion of the chamber 90, (3) reactive gas-supplier (e.g., a gas bottle 53 supplying a reactive gas through a control/regulator valve 57, pipe 39 and orifice 44 into a location inside the chamber in the vicinity of the ionized arc 66), and (4) substrate supporter-conveyor (e.g., conveying rollers 92a, 92b, 92c, 92d and belt 96).

An example of the ionized arc system constructed in accordance with the invention is shown in FIG. 1 The preparation of a thin, nano-grained coating begins with the vaporization of a precursor material 40 in the chamber 90 via an arc generated, for example, by a water-cooled tungsten inert gas torch 50 driven by a power supply 70. Although not a requirement, the interior of the chamber 90 is preferably maintained at a relative pressure of about 20 inches of mercury vacuum up to +3 psi positive pressure (absolute pressure 250 torr to 1000 torr).

The precursor material 40 is melted and vaporized by the transfer of arc energy from a non-consumable electrode 58, such as a thorium oxide-modified tungsten electrode. The non-consumable electrode 58 is shielded by a stream of an inert working gas 60 from a bottle 51 (through a gas control valve/regulator 57 and an orifice 62) to create the arc 66. The working gas 60 acts to shield the non-consumable electrode 58 from an oxidizing environment and then becomes a working plasma gas when it is ionized to a concentration large enough to establish an arc between the non-consumable electrode 58 and a consumable electrode 56.

The consumable precursor material 40 is preferably in the form of a rod or wire which has a diameter of typically from 0.1 mm to 5 mm and is fed horizontally relative to the non-consumable electrode 58. The feed wire or rod 40 of a precursor material (a metal, metal alloy, metal compound, or ceramic material) is continuously fed to maintain a stable arc and continuous production of nano-grained coatings. A continuous production is preferred over batch operation because the process can be run on a more consistent and cost-effective basis. The consumable electrode 56 is preferably water-cooled.

The non-consumable tungsten electrode 58 is preferably inclined at an angle with respect to the consumable electrode 56 so as to create an elongated arc flame 66. Depending on the current level, the arc flame 66 can be about one to several inches long. The arc flame 66 acts as a high temperature source to melt and vaporize the leading end 52 of the precursor material 40 to form a stream of vapor clusters that are atomic-, molecular, or nanometer-sized. A reactive gas (e.g. containing oxygen) is introduced from the bottle 53 through the orifice 44 into the arc 66. The amount of the reactive gas injected into the arc flame 66 is controlled by a gas flow meter-regulator 59. Preferably, a concentric gas injection geometry is established around the arc flame 66 to allow homogeneous insertion of the reactive gas. The reactive gas orifice 44 can be positioned at any point along the length of the arc flame 66 as shown in FIG. 1. The gas regulator or control meter valve 59 is used to adjust the gas flow rate as a way to vary the effective coating rate. The oxygen gas impinges upon the metal clusters to initiate and sustain an exothermic oxidation reaction between oxygen and precursor material clusters, thereby converting the ultra-fine clusters into depositable metal compound or ceramic clusters 85 that are in the liquid or, preferably, vapor state.

In an alternative embodiment of the presently invented method, a non-reactive gas or no gas is injected through orifice 44. In this case, the material composition of the resulting nanoporous coating will be the same as the precursor material. A non-reactive gas may be used to modulate or truncate the arc flame size, or simply to adjust the arc flame temperature.

The arc 66, being at an ultra-high temperature (up to 6,000° C.), functions to melt and vaporize the wire tip of the precursor material to generate nano-sized vapor clusters. A stream of working gas 60 from a source 51 exits out of the orifice 62 into the chamber to help maintain the ionized arc and to carry the stream of vapor clusters downward toward the lower portion of the coating chamber 90. Preferably, the working gas flow and the reactive gas are directed to move in a general direction toward the solid substrate (e.g. 94b) to be coated. In FIG. 1. as an example, this direction is approximately vertically downward.

The wire or rod 40 can be fed into the arc, continuously or intermittently on demand, by a wire-feeding device (e.g., powered rollers 54). The roller speed may be varied by changing the speed of a controlling motor.

The ultra-fine oxide clusters 85 are then directed to go through a heat treatment zone and are deposited onto a solid substrate (e.g., 94b) being supported by a conveyor belt 96 which is driven by 4 conveyor rollers 92a-92d. The lower portion of FIG. 1 shows a train of substrate glass pieces, including 94a (un-coated), 94b (being coated) and 94c (coated). The treat treatment zone serves to change the temperatures of the vapor clusters so that a non-zero proportion of the clusters become high-temperature solid particles, which are capable of partial sintering or sticking to each other at their points of contact. Alternatively, the clusters with proper heat treatments (e.g., cooling) may become a mixture of solid particles and/or liquid droplets and/or vapor clusters prior to striking onto the substrate surface. The liquid droplets and/or vapor clusters act to glue or bond together otherwise separate individual solid particles, still leaving behind a desired amount of minute pores. Since the clusters are nanometer-scaled, the resulting pores are also nanometer-scaled. In the case when all clusters remain in the liquid or vapor state just prior to impinging upon the substrate, the resulting coating tends to be relatively pore-free.

The clusters that are not deposited onto a substrate will be cooled to solidify and become solid powder particles. These powder particles, along with the residual gases, are transferred through a conduit to an optional powder collector/separator system (not shown).

In another embodiment of the invented system, the wire or rod is made up of two metal elements so that a mixture of two types of nano clusters can be produced for the purpose of depositing a hybrid or composite coating material.

In a preferred embodiment, the system as defined above may further include a separate plasma arc zone below the ionized arc 66 to vaporize any un-vaporized material dripped therefrom. For instance, a dynamic plasma arc device (e.g., with power source 74 and coils 76 in FIG. 1) may be utilized to generate a plasma arc zone 75 through which the un-vaporized melt droplets dripped out of the ionized arc 66 will have another chance to get vaporized. The creation of a plasma arc zone is well-known in the art. The ultra-high temperature in the plasma arc (up to as high as 32,000° K.) rapidly vaporizes the melt droplets that pass through the plasma arc zone.

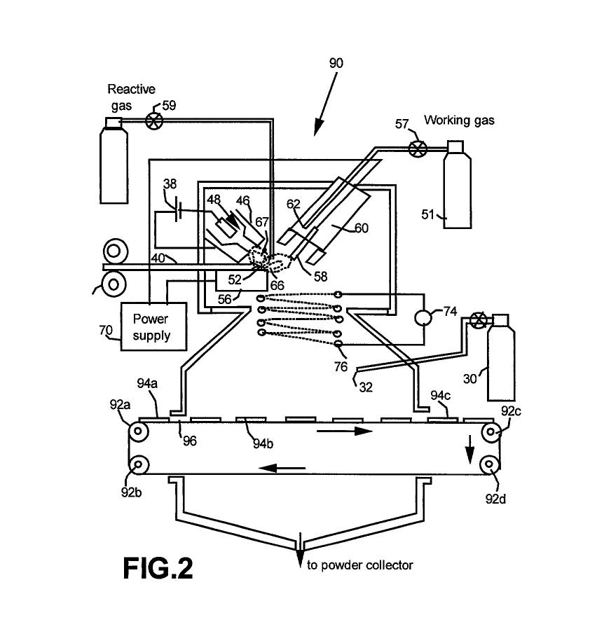

The ionized arc 66 tends to produce a metal melt pool or “weld pool” near the leading end 52 of the feed wire 40 on the top surface of the consumable electrode 56 if the arc tail temperature is not sufficiently high to fully vaporize the precursor material. The melt in this pool will eventually vaporize provided an arc is maintained to continue to heat this pool. For the purpose of reducing the duration of time required to fully vaporize the metal material and, hence, increase the coating production rate, it is preferable to operate at least a second plasma or ionized arc nozzle to generate at least a second arc (e.g., 67 in FIG. 2) near the leading end 52 of the feed wire 40. For instance, shown in FIG. 2 is a DC plasma arc nozzle 46 which is driven by a DC power source 38 and a working gas flow 48 to create an arc 67 to provide additional heat energy to the precursor wire tip 52.

For the purpose of clearly defining the claims, the word “wire” means a wire of any practical diameter, e.g., from several microns (a thin wire or fiber) to several centimeters (a long, thick rod). A wire can be supplied from a spool, which could provide an uninterrupted supply of a wire as long as several miles. This is a very advantageous feature, since it makes the related coating process a continuous one.

The presently invented method is applicable to essentially all metallic materials (including pure metals and metal alloys), metallic compounds and ceramic materials. As used herein, the term “metal” refers to an element of Groups 2 through 13, inclusive, plus selected elements in Groups 14 and 15 of the periodic table. Thus, the term “metal” broadly refers to the following elements:

Group 2 or IIA: beryllium (Be), magnesium (Mg), calcium (Ca), strontium (Sr), barium (Ba), and radium (Ra).

Groups 3-12: transition metals (Groups IIIB, IVB, VB, VIB, VIIB, VIII, IB, and IIB), including scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os). cobalt (Co), rhodium (Rh), iridium (Ir), nickel (Ni), palladium (Pd), platinum (Pt), copper (Cu), silver (Ag), gold (Au), zinc (Zn), cadmium (Cd), and mercury (Hg).

Group 13 or IIIA: boron (B), aluminum (Al), gallium (Ga), indium (In), and thallium (TI).

Lanthanides: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

Group 14 or IVA: germanium (Ge), tin (Sn), and lead (Pb).

Group 15 or VA: antimony (Sn) and bismuth (Bi).

When high service temperatures are not required, the component metal element may be selected from the low melting point group consisting of bismuth, cadmium, cesium, gallium, indium, lead, lithium, rubidium, tin, and zinc, etc. When a high service temperature is required, a metallic element may be selected from the high-melting refractory group consisting of tungsten, molybdenum, tantalum, hafnium and niobium. Alternatively, metal compounds or ceramic materials (oxides, nitrides, carbides, borides, silicides, etc.). Other metals with intermediate melting points such as copper, zinc, aluminum, iron, nickel and cobalt may also be selected.

Preferably the reactive gas includes oxygen and a gas selected from the group consisting of hydrogen, carbon, nitrogen, chlorine, fluorine, boron, iodine, sulfur, phosphorus, arsenic, selenium, tellurium and combinations thereof. Noble gases such as argon and helium may be used to adjust or regulate the oxidation rate. Other gases may be used to react with metal clusters to form nanometer-scale compound or ceramic powders of hydride, oxide, carbide, nitride, chloride, fluoride, boride, iodide, sulfide, phosphide, arsenide, selenide, and telluride, and combinations thereof. The method may further include operating means for providing dissociable inert gas mixable with the working gas. The dissociable inert gas serves to increase the temperature gradient in the ionized arc. The stream of reactive gas reacts with the vapor clusters in such a manner that the reaction heat released is used to sustain the reaction until most of the precursor vapor clusters are substantially converted to nanometer-sized metal compound or ceramic clusters. The stream of reactive gas is preferably pre-heated to a predetermined temperature prior to being injected to impinge upon the precursor vapor clusters. A higher gas temperature promotes or accelerates the conversion of metallic clusters to compound or ceramic clusters.

If the reactive gas contains a reactive gas (e.g., oxygen), this reactive gas will rapidly react with the precursor material clusters to form nanometer-sized ceramic clusters (e.g., oxides). If the reactive gas contains a mixture of two or more reactive gases (e.g., oxygen and nitrogen), the resulting product will contain a mixture of two compounds or ceramics (e.g., oxide and nitride). If the metal wire is a metal alloy or mixture (e.g., containing both indium and tin elements) and the reactive gas is oxygen, the resulting product will contain ultra-fine indium-tin oxide particles.

In summary, a preferred embodiment of the present invention is a method for producing a nano-porous coating onto a solid substrate. The method includes the following steps: (a) providing an ionized arc nozzle that includes a consumable electrode, a non-consumable electrode, and a working gas flow to form a first ionized arc between the two electrodes, wherein the consumable electrode provides a precursor material vaporizable from the consumable electrode by the ionized arc; (b) operating the arc nozzle to heat and at least partially vaporize the precursor material for providing a stream of nanometer-sized vapor clusters into a chamber in which the substrate is disposed; (c) introducing a stream of reactive gas (e.g., oxygen-containing gas) into the chamber to impinge upon the stream of precursor vapor clusters and exothermically react therewith to produce substantially nanometer-sized metal compound or ceramic clusters (e.g., oxide clusters); (d) heat treating the clusters to convert a proportion of the vapor clusters into high temperature solid particles and (e) directing the clusters (including these solid particles) to deposit onto the substrate for forming the nano-porous coating. The step (d) of operating heat treatment means includes a step of injecting a stream of cool gas to impinge upon the vapor clusters.

Optionally, the method may include another step of operating a plasma arc means (e.g., a dynamic plasma device including a high-frequency power source 74 and coils 76) for vaporizing any un-vaporized compound or ceramic clusters or droplets after step (c) and before step (d). Also optionally, the method may include an additional step of operating at least a second ionized arc means (e.g., a DC plasma arc nozzle 46 in FIG. 2) for vaporizing any un-vaporized precursor material after step (b) or metal compound or ceramic clusters after step (c) but before step (d).

The step of operating heat treatment means may include a step of injecting a stream of cool gas (e.g., from gas cylinder 30 and exiting at 32) to impinge upon the vapor clusters in such a fashion that a non-zero proportion of the vapor clusters are converted into solid clusters being at a temperature sufficient to cause partial sintering between individual solid clusters. The step of operating heat treatment means may be carried out in such a fashion that the vapor clusters are converted to become a mixture of solid clusters and liquid clusters or a mixture of solid, liquid, and vapor clusters. The resulting coatings obtained under these conditions were found to be nano-grained and nano-porous.

In the presently invented method, the step of operating an arc nozzle means to heat and at least partially vaporize the wire of a precursor composition may include a sub-steps of melting the wire and atomizing the resulting metal melt to form nanometer-scaled liquid droplets of the precursor material. The liquid droplets are mixed with or become a part of the stream of vapor clusters. Atomization produces ultra-fine droplets that promote vaporization of the precursor material melt and accelerate the reaction between the precursor material and the reactive gas injected into the arc zone. Gas atomization, ultrasonic atomization, magnetic field blowing, etc. may be used to achieve the break-up of a weld pool into an aerosol of liquid droplets. The liquid droplets readily react with the reactive gas to form nano-scaled metal compound or ceramic clusters.

In the presently invented method, the stream of reactive gas or oxygen-containing gas may further include a small amount of a second gas to produce a small proportion of compound or ceramic clusters that could serve to modify the properties of the otherwise pure oxide coating. This second gas may be selected from the group consisting of hydrogen, carbon, nitrogen, chlorine, fluorine, boron, sulfur, phosphorus, arsenic, selenium, tellurium and combinations thereof.

Preferably, the solid substrate in the practice of the present method includes a train of individual pieces of a glass, plastic, metal, or ceramic solid being moved sequentially or concurrently into coating chamber and then moved out of the chamber after the coating is formed. This feature will make the process a continuous one.

In another embodiment of the method, the precursor material may include an alloy or mixture of at least two metallic elements, with a primary one occupying more than 95% and the minor one less than 5% by atomic number. The primary one is selected so that its metal vapor clusters can be readily converted to become oxides or other ceramic clusters. However, the minor one may be allowed to remain essentially as nano-sized metal clusters. Upon deposition onto the substrate, the minor metal element only serves as a modifier to the properties (e.g., to increase the electrical conductivity) of the oxide coating. The presence of a small amount of nano-scaled metal domains does not adversely affect other physical properties (e.g., strength or optical transparency) of the oxide coating.

The resulting coating on a solid substrate may be separated from the substrate to obtain a thin nano-porous film by a physical or chemical means. In some cases, the coating can be readily peeled off from a substrate (e.g., a plastic substrate). A lower temperature substrate may be melted away to recover the film. A polymer substrate may be chemically etched away or dissolved in a solvent to obtain a thin nano-porous film or membrane.

### EXAMPLE 1

A metal rod of Al, Cu, Fe, Sn, Ti, Zn, or Zr of ⅛-1 inches diameter was used as a precursor material disposed on a top horizontal surface of the consumable electrode. The non-consumable electrode, which was used as a cathode, was a material consisting of 2% thoriate dispersed in a matrix of W. This electrode was shielded by 25-100 cfh of a working gas of argon combined with 5-100% nitrogen and/or 5-50% hydrogen. The current of the arc was adjusted between approximately 100 and 450 amps, which generated an arc tail flame 1-4 inches long that evaporated the precursor material. The arc created a stream of metal vapor clusters of 1-200 g/hr while an oxygen flow of 10-1000 cfh was injected into the tail flame to form an oxide species of the starting metal. Cooling of metal-oxide clusters to a temperature slightly lower than the corresponding oxide melting point produce a small amount of high-temperature solid particles, along with a majority of liquid droplets and vapor clusters. These solid particles, liquid droplets, and vapor clusters were directed to deposit on a substrate that ranges from metal-coated plastic, metal foil, to glass. The micro-structure of the resulting coatings was typically characterized by grain sizes in the range of 1-50 nm with pores of a similar size range.

### EXAMPLE 2

A powder mixture of 70% zinc and 30% zinc oxide was compounded into a rod ½″ diameter by pressing and sintering. The rod was electrically conductive and used as a precursor material in the consumable electrode or anode. The same cathode as in Example 1 was used and shielded by approximately 50 cfh of a working gas of argon in combined with 5-50% nitrogen or 5-50% hydrogen. The current of the arc ranged from 100-450 amps. The precursor material was evaporated by the arc to produce a vapor of 1-200 g/hr in a plasma tail flame created by the transferred arc. Concurrently, 10-500 cfh oxygen was injected into the tail flame to produce complete zinc oxide particles. Cooling air (1-500 cfm) was introduced into the lower portion of the coating chamber, as a means of heat treatment, to partially solidify the oxide clusters. This mixture of oxide particles and clusters was directed to deposit onto an aluminum foil. The coatings were found to be nano-grained (5-75 nm) with pore sizes of 2-50 nm.

### EXAMPLE 3

The process of Example 1 was repeated except that a thin aluminum wire (approximately ⅛ inches or 3 mm in diameter) was supplied as a precursor material at an advancing rate of 15 cm/min. Nitrogen gas, instead of oxygen, was introduced at a rate of 100 cfh to impinge upon the aluminum vapor clusters generated by an arc flame. The resulting AlN coating was nano-grained (grain sizes ranging from 35 nm to 125 nm) and nano-porous (pore sizes of 30 nm to 75 nm).

What is claimed:

1. A method for producing a nano-porous coating onto a solid substrate from a precursor material selected from the group consisting of a metal, metal alloy, metal compound, and ceramic material, said method comprising:
(a) providing an ionized arc nozzle means comprising a consumable electrode, a non-consumable electrode, and a working gas flow to form an ionized arc between said consumable electrode and said non-consumable electrode, wherein said consumable electrode provides said precursor material vaporizable therefrom by said ionized arc;
(b) operating said arc nozzle means to heat and at least partially vaporize said precursor material for providing a stream of nanometer-sized vapor clusters of said precursor material into a chamber in which said substrate is disposed;
(c) introducing a stream of reactive gas into said chamber to impinge upon said stream of vapor clusters and exothermically react therewith to produce substantially nanometer-sized metal compound or ceramic clusters; and
(d) operating heat treatment means to heat treat said metal compound or ceramic clusters so that a non-zero proportion of said clusters are in a solid state when impinging upon said substrate; and
(e) directing said metal compound or ceramic clusters to impinge upon and deposit onto said substrate for forming said nano-porous coating.

2. A method for producing a nano-porous coating onto a solid substrate from a precursor material selected from the group consisting of a metal, metal alloy, metal compound, and ceramic material, said method comprising:
(a) providing an ionized arc nozzle means comprising a consumable electrode, a non-consumable electrode, and a working gas flow to form an ionized arc between said consumable electrode and said non-consumable electrode, wherein said consumable electrode provides said precursor material vaporizable therefrom by said ionized arc;
(b) operating said arc nozzle means to heat and at least partially vaporize said precursor material for providing a stream of nanometer-sized vapor clusters of said precursor material into a chamber in which said substrate is disposed;
(c) operating heat treatment means to heat treat said clusters so that a non-zero proportion of said clusters are in a solid state when impinging upon said substrate; and
(d) directing said clusters to impinge upon and deposit onto said substrate for forming said nano-porous coating.

3. The method as set forth in claim 1 or 2, further comprising a step of operating at least a second ionized arc nozzle means for the purpose of completely vaporizing said precursor material.

4. The method as set forth in claim 1, further comprising a step of operating an additional plasma arc means for vaporizing any un-vaporized metal compound or ceramic clusters after step (c) and before step (d).

5. The method as set forth in claim 1 or 2, wherein said precursor material comprises at least one metallic element selected from the low melting point group consisting of bismuth, cadmium, antimony, cesium, gallium, indium, lead, lithium, rubidium, tin, and zinc.

6. The method as set forth in claim 1, wherein said stream of reactive gas comprises a gas selected from the group consisting of hydrogen, oxygen, carbon, nitrogen, chlorine, fluorine, boron, sulfur, phosphorus, selenium, tellurium, arsenic and combinations thereof.

7. The method as set forth in claim 1 or 2, wherein said step of operating heat treatment means includes a step of injecting a stream of cool gas to impinge upon said vapor clusters.

8. The method as set forth in claim 1 or 2, wherein said substrate comprises a train of individual pieces of solid substrate material being moved sequentially or concurrently into said chamber and then moved out of said chamber after said coating is formed.

9. The method as set forth in claim 1 or 2, wherein said precursor material comprises an alloy of at least two metallic elements.

10. The method as set forth in claim 1, wherein said stream of reactive gas reacts with said vapor clusters in such a manner that the reaction heat released is used to sustain the reaction until most of said precursor vapor clusters are substantially converted to nanometer-sized metal compound or ceramic clusters.

11. The method as set forth in claim 1, wherein said stream of reactive gas is pre-heated to a predetermined temperature prior to being injected to impinge upon said metal vapor clusters.

12. The method as set forth in claim 1 or 2, wherein said non-zero proportion of solid clusters are at a temperature sufficient to cause partial sintering between said solid clusters.

13. The method as set forth in claim 1 or 2, wherein the step of operating heat treatment means is carried out in such a fashion that said clusters are a mixture of solid clusters and liquid clusters.

14. The method as set forth in claim 1 or 2, wherein the step of operating heat treatment means is carried out in such a fashion that said clusters are a mixture of solid, liquid, and vapor clusters.

15. The method as defined in claim 1 or 2, wherein the step of operating an arc nozzle means to heat and at least partially vaporize the wire of a precursor composition includes the sub-steps of melting the wire and atomizing the resulting metal melt to form nanometer-scaled liquid droplets of said precursor material, said liquid droplets becoming mixed with said stream of vapor clusters.

16. The method as defined in claim 14, wherein said liquid droplets react with said reactive gas to form nano-scaled metal compound or ceramic clusters.

17. The method as defined in claim 1 or 2, further including a step of separating said coating from said substrate to obtain a nano-porous film.
